(19) United States
(12) Patent Application Publication
(10) Pub. No.: US 2014/0356598 A1
(43) Pub. Date: Dec. 4, 2014

(54) RE-ADHESIVE MULTI-LAYERED DOUBLE-SIDED TAPE AND MANUFACTURING METHOD THEREOF

(71) Applicant: TMS Co., Ltd., Paju-si (KR)

(72) Inventor: Chang Yong LEE, Hwaseong-si (KR)

(21) Appl. No.: 13/906,841

(22) Filed: May 31, 2013

(30) Foreign Application Priority Data
May 29, 2013 (KR) 10-2013-0060974

(51) Int. Cl. C09J 7/02

(52) U.S. Cl. CPC C09J 7/02; C09J 2467/006
USPC 428/214; 427/559; 428/353; 428/213

(57) ABSTRACT

A re-adhesive multi-layered double-sided tape which has its interlayer adhesion reinforced and improves reliability, and a manufacturing method thereof are provided. The re-adhesive multi-layered double-sided tape includes: a base layer; primer layers which are formed on opposite surfaces of the base layer; and re-adhesive adhesion layers which are formed on the primer layers.

### CROSS-REFERENCE TO RELATED APPLICATION

This application claims priority from Korean Patent Application No. 2013-0060974, filed on May 29, 2013 in the Korean Intellectual Property Office, the disclosure of which is incorporated herein by reference in its entirety.

### BACKGROUND

1. Field

Methods and apparatuses consistent with exemplary embodiments relate to a re-adhesive multi-layered double-sided tape and a manufacturing method thereof, and more particularly, to a re-adhesive multi-layered double-sided tape which has its interlayer adhesion reinforced and thus can improve reliability, and a manufacturing method thereof.

2. Description of the Related Art

Double-sided tapes for stationary purpose are used to fix documents, photos, decorations, albums, or accessories to walls or tables in general household and offices. An adherend fixed by means of such a double-sided tape for stationary purpose may need to be moved or the tape may need to be removed after a predetermined time. At this time, if a re-adhesive double-sided tape is used, the adherend can adhere to another surface, and, there is no residue of the adhesive in the previous surface after the tape is removed and it is easy to remove the tape.

The re-adhesive double-sided tape should have an adhering property of a certain level since the re-adhesive double-sided tape should stick an adherend on a surface within a predetermined time, and also, should be detachable since the re-adhesive double-sided tape should be removed from the surface after a predetermined time. To achieve this, the re-adhesive double-sided tape uses an adhesive that has adhesion of more than a predetermined level rather than having high adhesion.

The re-adhesive double-sided tape can be used several times as long as its surface adhesion is maintained. However, if foreign substances are attached to a surface of the adhesive, the adhesion is greatly reduced and thus the adhering property may be lost. Also, it is common that the re-adhesive double-sided tape has opposite surfaces of an intermediate base layer coated with an adhesive, and the adhesive may be a measure of the re-adhering property. Therefore, the adhesion of the adhesive is lower than that of a general double-sided tape and thus adhesion of the adhesive to the base layer is also low. Therefore, cohesion between the base layer and the re-adhesive adhesion layer is low and the base layer and the adhesion layer may be detached from each other. Thus, there are problems in that the re-adhesive double-side tape may be broken and the adherend may be detached from the surface.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a re-adhesive multi-layered double-sided tape which has its interlayer adhesion reinforced and thus can improve reliability, and a manufacturing method thereof.

According to an aspect of an exemplary embodiment, there is provided a re-adhesive multi-layered double-sided tape including: a base layer; primer layers which are formed on opposite surfaces of the base layer; and re-adhesive adhesion layers which are formed on the primer layers.

The base layer may include polyethyleneterephthalate. The primer layer may include a monomer, a first photo initiator, a second photo initiator, and a crosslinker. The re-adhesive adhesion layer may include a monomer, a first photo initiator, a second photo initiator, and a crosslinker.

At least one of the primer layer and the re-adhesive adhesion layer may include a chain transfer agent (CTA). The CTA may be a mercaptan-based CTA.

At least one of the primer layer and the re-adhesive adhesion layer may include a thermally cross-linkable curing agent. The thermally cross-linkable curing agent may be an epoxy thermally cross-linkable curing agent.

A thickness of the primer layer may be thicker than that of the base layer and may be thinner than that of the adhesion layer. A ratio of a thickness of the base layer and a thickness of the primer layer may be more than 3:4.

According to an aspect of another exemplary embodiment, there is provided a method for manufacturing a re-adhesive multi-layered double-sided tape, the method including: forming primer layers by coating opposite surfaces of a base layer with primer layers and photo-curing the primer layers; and forming an adhesion layer by coating the primer layer with a re-adhesive adhesion layer and photo-curing the re-adhesive adhesion layer.

The forming the primer layers may include: photo-curing a first primer mixture in which a primer monomer and a first primer layer photo initiator are mixed; and coating the opposite surfaces of the base layer with a second primer mixture in which a second primer layer photo initiator and a first primer layer crosslinker are added to the first primer mixture, and photo-curing the second primer mixture.

The forming the re-adhesive adhesion layer may include: photo-curing a first adhesion layer mixture in which an adhesion layer monomer and a first adhesion layer photo initiator are mixed; and coating the primer layer with a second adhesion layer mixture in which a second adhesion layer photo initiator and an adhesion layer crosslinker are added to the first adhesion layer mixture, and photo-curing the second adhesion layer mixture.

At least one of the primer layer and the re-adhesive adhesion layer may include a thermally cross-linkable curing agent, The method may further include, after photo-curing, thermally crosslinking and curing the primer layer and the re-adhesive adhesion layer. The thermally crosslinking and curing may be performed at a temperature of 60° C. within 24 hours.

The re-adhesive multi-layered double-sided tape according to the exemplary embodiment has the effect of reinforcing adhesion between the base layer and the primer layer and adhesion between the primer layer and the re-adhesive adhesion layer. Also, thicknesses of the base layer, the primer layer, and the re-adhesive adhesion layer are optimally set and thus performance of the re-adhesive double-sided tape is also optimized.

### DETAILED DESCRIPTION OF EXEMPLARY EMBODIMENTS

Hereinafter, exemplary embodiments will be described in greater detail.

The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

A re-adhesive multi-layered double-sided tape according to an exemplary embodiment includes a base layer, primer layers which are formed on opposite surfaces of the base layer, and re-adhesive adhesion layers which are formed on the primer layers. Therefore, the re-adhesive double-sided tape according to the exemplary embodiment is comprised of at least five layers, including the intermediate base layer, the primer layers formed on the opposite surfaces of the base layer, and the re-adhesive adhesion layers formed on the primer layers. Also, although one primer layer and one re-adhesive adhesion layer are formed on the base layer in the present exemplary embodiment, the re-adhesive double-sided tape may include two or more primer layers formed on the base layer and two or more re-adhesive adhesion layers formed on the primer layer.

The base layer of the re-adhesive double-sided tape may use a plastic film, and material for the base layer may be selected considering compatibility with the re-adhesive adhesive. For example, the base layer may use polyethyleneterephthalate (PET).

The re-adhesive adhesion layer is an adhesion layer that is re-adhesive to other surfaces. Specifically, when an adherend is attached to the re-adhesive adhesion layer, the re-adhesive adhesion layer can adhere to the adherend for a predetermined time and also can be easily removed from the adherend after a predetermined time, and also, does not leave a residue on the surface of the adherend. That is, the re-adhesive adhesion layer that has adhered to a first adherend and removed from it can adhere to a second adherend.

The re-adhesive adhesion layer may use a pressure sensitive adhesive (PSA). The PSA is an adhesive that has an adhesive substance acted when a pressure is applied to stick the adhesive and the adherend. A structural adhesive to continuously maintain adhesion is coagulated by evaporation of a solvent, ultraviolet light (UV) radiation, chemical reaction, or cooling in order to adhere to a surface, and thus has no ability to re-adhere to other surfaces. However, unlike this structural adhesive, the PSA adheres to the adherend only using pressure and thus can be used for the re-adhesive adhesion layer.

The PSA may use various kinds of adhesives. For example, an acrylic photo-polymerized adhesive may be used. That is, an adhesive that is photo-polymerized using a photo initiator may be used as an acrylic adhesive.

Any monomer that can have the ability to re-adhere by being polymerized may be used as an acrylic monomer. For example, the acrylic monomer may use, but not limited to, 2-ethyl hexyl acrylate, isooctyl acrylate, butyl acrylate, acrylic acid, 2-hydroxy ethyl acrylate, phenoxyethyl acrylate, isobornyl acrylate, dicyclopentenyl acrylate, acrylic amide, dimethyl acrylic amide, isobutyl methylacrylate, n-(2-hydroxyethyl)acrylamide, 9,9-Bis[4-(2-acryloyloxyethoxy)phenyl]fluorene, tetra-bromobisphenol A-diglycidyletherdiacrylate, (CAS Number: 66696-45-5), 4-hydroxybutyl acrylate (CAS Number: 2478-10-6), or trimethylolpropane trimethacrylate (CAS Number: 3290-92-4) (stabilized with MEHQ).

Since the re-adhesive multi-layered double-sided tape should be configured to be repeatedly used, durability of the adhesion layer should be guaranteed. Accordingly, the adhesion layer included in the re-adhesive multi-layered double-sided tape may be thicker than that of a general tape. The adhesive included in the adhesion layer may use a polymerized adhesive. The polymerization may be performed in a heat-polymerization method or a photo-polymerization method.

In the heat-polymerization method, the adhesion layer is formed by drying a composition in which the adhesive is dissolved in an organic solvent with heat and evaporating the organic solvent and leaving only the adhesive. Such a heat-polymerization method puts a limit to thickness of the adhesion layer. In order to form a very thick adhesion layer, a large amount of organic solvent is required to dissolve the adhesive. However, when the organic solvent is dried with heat, the large amount of organic solvent is evaporated and thus bubbles are generated on a surface of the adhesion layer and cause a defect in the adhesion layer. Therefore, it is preferable to use the photo-polymerization method rather than the heat-polymerization method in order to manufacture a double-sided tape of more than a predetermined thickness.

The re-adhesive adhesion layer may include a monomer, a first photo initiator, a second photo initiator, and a crosslinker. To form the re-adhesive adhesion layer, a polymer is formed first by adding the first photo initiator to the monomer mixture and then irradiating the monomer mixture with light. The polymer mixture which is photo-polymerized is a liquefied mixture having a predetermined viscosity (500 to 5000 cps).

After that, the adhesion layer is formed by performing photo-polymerization and crosslinking, specifically, by adding the second photo initiator and the crosslinker to the first photo-polymerized polymer mixture, coating a surface on which the adhesion layer is to formed with the polymer mixture, and irradiating the surface with light.

If the re-adhesive adhesion layer is directly formed on the base layer, the re-adhesive adhesion layer may be detached from the base layer due to its low adhesion. The primer layer is to prevent the detachment of the re-adhesive adhesion layer from the base layer. The primer layer is formed considering both cohesion with the base layer and cohesion with the re-adhesive adhesion layer.

The primer layer is a layer for improving cohesion between the base layer and the re-adhesive adhesion layer, considering components of the two layers, and may contain adhesion. Since the primer layer is a kind of adhesion layer, the primer layer may be formed by polymerizing an acrylic monomer like the re-adhesive adhesion layer. Since it is not necessary to form the primer layer thick unlike the re-adhesive adhesion layer, the primer layer may be formed by heat-polymerization. However, since the primer layer may be formed along with the re-adhesive adhesion layer by being coated along with the re-adhesive adhesion layer and irradiated with light simultaneously, the primer layer may be formed by photo-polymerization. Therefore, the primer layer may be formed using an acrylic photo-polymerized monomer, or using an acrylic monomer which may be used for the above-described re-adhesive adhesion layer.

The primer layer may include a monomer, a first photo initiator, a second photo initiator, and a crosslinker. In order to form the primer layer, a polymer is formed first by adding the first photo initiator to the monomer mixture and irradiating the monomer mixture with light. The polymer mixture which is photo-polymerized is a liquefied mixture having a predetermined viscosity (500 to 5000 cps).

After that, the primer layer is formed by performing photo-polymerization and crosslinking, specifically, by adding the second photo initiator and the crosslinker to the first photo-polymerized polymer mixture, coating the base layer with the polymer mixture, and irradiating the base layer with light.

Since the first polymerized polymer mixture is a liquefied mixture having a predetermined viscosity when the re-adhesive adhesion layer and the primer layer are formed, the second photo initiator and the crosslinkers are added to the first polymerized polymer mixture. The base layer is coated with the primer layer, and the primer layer is photo-cured by light irradiation. Then, the re-adhesive adhesion layer is coated over the primer layer and photo-cured. In this way, the re-adhesive multi-layered double-sided tape is manufactured.

At this time, the primer layer and the re-adhesive adhesion layer may react with each other when the re-adhesive adhesion layer is photo-cured. If the primer layer is thin, the re-adhesive adhesion layer may be brought into contact with the base layer due to the reaction with the primer layer. When the re-adhesive adhesion layer is brought into contact with the base layer, the re-adhesive adhesion layer is likely to be detached from the base layer. Accordingly, the primer layer is so thick that the re-adhesive adhesion layer is not brought into contact with the base layer after being photo-cured. For example, the primer layer may be thicker than the base layer. However, if the primer layer is very thick, an additional layer to connect the baser layer and the re-adhesive adhesion layer would be thick and thus the primer layer may be thinner than the re-adhesive adhesion layer.

When the primer layer and the re-adhesive adhesion layer react with each other due to the light irradiation after the base layer is coated with a mixture in which the second photo initiator and the crosslinker are added to the first polymerized polymer mixture, if molecular weight is uniform and a conversion ratio is high, the adhesion may be improved. To achieve this, at least one of the primer layer and the re-adhesive adhesion layer may include a chain transfer agent (CTA).

The CTA increases the conversion ratio of the first polymerized polymer mixture of the primer layer and the re-adhesive adhesion layer, and makes the molecular weight uniform. The CTA may be a mercaptan-based CTA. The mercaptan-based CTA may use at least one of, but not limited to, normal dodecyl mercaptan, tertiary dodecyl mercaptan, and n-octyl mercaptan.

Also, at least one of the primer layer and the re-adhesive adhesion layer may include a thermally cross-linkable curing agent. An epoxy-based monomer or epoxy-based oligomer has a thermally cross-linkable curing property. Accordingly, if the epoxy-based monomer or epoxy-based oligomer is added to the primer layer or the re-adhesive adhesion layer and heat-curing is performed after second photo-polymerization, thermal cross-linking and curing occur in the primer layer or the re-adhesive adhesion layer, and thus cohesion between the base layer and the primer layer or between the primer layer and the re-adhesive adhesion layer is improved.

The epoxy thermally cross-linkable curing agent may use at least one of, but not limited to, glycidyl methacrylate monomer, bisphenol A epoxy acrylate oligomer, phenyl epoxy acrylate oligomer, and aliphatic alkyl epoxy acrylate oligomer.

If thermal cross-linking and curing temperature is very low, the thermal cross-linking and curing do not affect to the extent that the cohesion of the base layer, the primer layer, and the re-adhesive adhesion layer is improved. If the temperature is very high or the thermal cross-linking and curing step are performed for a long time, a degree of crosslinking increases and thus a tacking property is reduced. Also, if the thermal cross-linking and curing are performed for a short time like 12 hours, incomplete thermal cross-linking and curing may be performed like in the case in which the thermal cross-linking and curing temperature is very low. Therefore, it is preferable that the thermal cross-linking and curing are performed at 60° C. within 24 hours.

Hereinafter, examples will be explained in detail.

1. Manufacturing of Primer Layer and Re-Adhesive Adhesion Layer

In examples 1 and 2, primer layers were manufactured. In comparison examples 1 and 2, primer layers were manufactured in the same way except for that a CTA and a thermally cross-linkable curing agent were not added in comparison example 1, and only the thermally cross-linkable curing agent was not added in comparison example 2. Also, in examples 3 and 4, re-adhesive adhesion layers were manufactured. In comparison examples 3 and 4, re-adhesive adhesion layers were manufactured in the same way except for that a CTA and a thermally cross-linkable curing agent were not added in comparison example 3, and only the thermally cross-linkable curing agent was not added in comparison example 4.

<Manufacturing Method>

In order to form the primer layer and the re-adhesive adhesion layer, a monomer of an acrylic polymer was injected into a 3-neck flask, a nitrogen gas was introduced, and the monomer was agitated for 2 hours. After oxygen was removed from such a polymerization system, a first photo initiator was added and then the mixture was irradiated with UV light of a UV lamp and is reacted (first polymerization).

Comparison examples 1 and 3 were conducted by injecting a second photo initiator and a photo-curing crosslinker to the liquefied acrylic polymer mixture which was obtained through the first polymerization, and UV-curing the mixture (second polymerization). In comparison examples 2 and 4, a CTA was added, and, in examples 1 to 4, the primer layer and the re-adhesive adhesion layer were obtained by adding a CTA and a thermally cross-linkable curing agent.

Following table 1 shows examples and comparison examples of the primer layer, and table 2 show additives and contents in examples and comparison examples of the re-adhesive adhesion layer:

TABLE 1

| | | | Comparison | Comparison |
|---|---|---|---|---|
| | Example 1 | Example 2 | Example 1 | Example 2 |
| Monomer | 40 parts by | 40 parts by | 40 parts by | 40 parts by |
| | weight of | weight of | weight of | weight of |
| | 2-ethyl | 2-ethyl | 2-ethyl | 2-ethyl |
| | hexyl | hexyl | hexyl | hexyl |
| | acrylate | acrylate | acrylate | acrylate |
| | 30 parts by | 30 parts by | 30 parts by | 30 parts by |
| | weight of | weight of | weight of | weight of |
| | 2-hydroxy | 2-hydroxy | 2-hydroxy | 2-hydroxy |
| | ethyl | ethyl | ethyl | ethyl |
| | acrylate | acrylate | acrylate | acrylate |
| | 10 parts by | 10 parts by | 10 parts by | 10 parts by |
| | weight of | weight of | weight of | weight of |
| | bis fluorene | bis fluorene | bis fluorene | bis fluorene |
| | 10 parts by | 10 parts by | 10 parts by | 10 parts by |
| | weight of | weight of | weight of | weight of |
| | diglycidyl- | diglycidyl- | diglycidyl- | diglycidyl- |
| | ether- | ether- | ether- | ether- |
| | diacrylate | diacrylate | diacrylate | diacrylate |
| First | 0.2 parts by | 0.2 parts by | 0.2 parts by | 0.2 parts by |
| photo | weight of | weight of | weight of | weight of |
| initiator | α- | α- | α- | α- |
| | hydroketone | hydroketone | hydroketone | hydroketone |
| | photo | photo | photo | photo |
| | initiator | initiator | initiator | initiator |
| Second | 0.5 parts by | 0.5 parts by | 0.5 parts by | 0.5 parts by |
| photo | weight of | weight of | weight of | weight of |
| initiator | hydroxcy- | hydroxcy- | hydroxcy- | hydroxcy- |
| | cyclohexyl | cyclohexyl | cyclohexyl | cyclohexyl |
| | phenyl- | phenyl- | phenyl- | phenyl- |
| | ketone | ketone | ketone | ketone |
| Cross- | 0.5 parts by | 0.5 parts by | 0.5 parts by | 0.5 parts by |
| linker | weight of | weight of | weight of | weight of |
| | 1,6- | 1,6- | 1,6- | 1,6- |
| | hexandiol | hexandiol | hexandiol | hexandiol |
| | diacrylate | diacrylate | diacrylate | diacrylate |
| CTA | 0.2 parts by | 0.2 parts by | — | 0.2 parts by |
| | weight of | weight of | | weight of |
| | tert-dodecyl | tert-dodecyl | | tert-dodecyl |
| | mercaptan | mercaptan | | mercaptan |
| Thermally | 0.2 parts by | 0.2 parts by | — | — |
| cross- | weight of | weight of | | |
| linkable | glycidyl | aliphatic | | |
| curing | methacrylate | alkyl epoxy | | |
| agent | monomer | acrylate | | |
| | | oligomer | | |

TABLE 2

| | | | Comparison | Comparison |
|---|---|---|---|---|
| | Example 1 | Example 2 | Example 1 | Example 2 |
| Monomer | 80 parts by | 80 parts by | 80 parts by | 80 parts by |
| | weight of | weight of | weight of | weight of |
| | 2-ethyl | 2-ethyl | 2-ethyl | 2-ethyl |
| | hexyl | hexyl | hexyl | hexyl |
| | acrylate | acrylate | acrylate | acrylate |
| | 10 parts by | 10 parts by | 10 parts by | 10 parts by |
| | weight of | weight of | weight of | weight of |
| | 2-hydroxy | 2-hydroxy | 2-hydroxy | 2-hydroxy |
| | ethyl | ethyl | ethyl | ethyl |
| | acrylate | acrylate | acrylate | acrylate |
| | 2 parts by | 2 parts by | 2 parts by | 2 parts by |
| | weight of | weight of | weight of | weight of |
| | n-(2- | n-(2- | n-(2- | n-(2- |
| | hydroxy- | hydroxy- | hydroxy- | hydroxy- |
| | ethyl) | ethyl) | ethyl) | ethyl) |
| | acrylamide | acrylamide | acrylamide | acrylamide |
| | 2 parts by | 2 parts by | 2 parts by | 2 parts by |
| | weight of | weight of | weight of | weight of |
| | trimethyl | trimethyl- | trimethyl- | trimethyl- |
| | -olpropane | olpropane | olpropane | olpropane |
| | trimeth- | trimeth- | trimeth- | trimeth- |
| | acrylate | acrylate | acrylate | acrylate |
| | 2 parts by | 2 parts by | 2 parts by | 2 parts by |
| | weight of | weight of | weight of | weight of |
| | N,N-dimethyl | N,N-dimethyl | N,N-dimethyl | N,N-dimethyl |
| | acrylamide | acrylamide | acrylamide | acrylamide |
| First | 0.2 parts by | 0.2 parts by | 0.2 parts by | 0.2 parts by |
| photo | weight of | weight of | weight of | weight of |
| initiator | α- | α- | α- | α- |
| | hydroketone | hydroketone | hydroketone | hydroketone |
| | photo | photo | photo | photo |
| | initiator | initiator | initiator | initiator |
| Second | 0.5 parts by | 0.5 parts by | 0.5 parts by | 0.5 parts by |
| photo | weight of | weight of | weight of | weight of |
| initiator | hydroxcy- | hydroxcy- | hydroxcy- | hydroxcy- |
| | cyclohexyl | cyclohexyl | cyclohexyl | cyclohexyl |
| | phenyl- | phenyl- | phenyl- | phenyl- |
| | ketone | ketone | ketone | ketone |
| Cross- | 0.5 parts by | 0.5 parts by | 0.5 parts by | 0.5 parts by |
| linker | weight of | weight of | weight of | weight of |
| | 1,6-hexandiol | 1,6-hexandiol | 1,6-hexandiol | 1,6-hexandiol |
| | diacrylate | diacrylate | diacrylate | diacrylate |
| CTA | 0.2 parts by | 0.2 parts by | — | 0.2 parts by |
| | weight of | weight of | | weight of |
| | tert-dodecyl | tert-dodecyl | | tert-dodecyl |
| | mercaptan | mercaptan | | mercaptan |
| Thermally | 0.2 parts by | 0.2 parts by | — | — |
| cross- | weight of | weight of | | |
| linkable | glycidyl | aliphatic | | |
| curing | methacrylate | alkyl epoxy | | |
| agent | monomer | acrylate | | |
| | | oligomer | | |

<Experiment Method>

A crosscut test was conducted for examples 1 to 4 and comparison examples 1 to 4. The crosscut test was a test that made a grid pattern by drawing lines on a test piece at intervals of 1 mm (11 vertical lines*11 horizontal lines: 100 cells), and sticked an oriented polypropylene (OPP) tape and then strongly pulled the tape three times in a vertical direction. A criterion for judging was determined on the assumption that a machined surface was not peeled when the OPP tape was detached.

TABLE 3

| | | | Comparison | Comparison | | | Comparison | Comparison |
|---|---|---|---|---|---|---|---|---|
| | Example 1 | Example 2 | Example 1 | Example 2 | Example 3 | Example 4 | Example 3 | Example 4 |
| Number | 0 | 0 | 30 | 8 | 0 | 0 | 23 | 12 |
| of Peeled | | | | | | | | |
| cells | | | | | | | | |
| Judgment | Good | Good | Poor | Poor | Good | Good | Poor | Poor |

As shown in table 3, the primer layers of examples 1 and 2 in which the CTA and the thermally cross-linkable curing agent were used, and the re-adhesive adhesion layer of examples 3 and 4 in which the CTA and the thermally cross-linkable curing agent were used, had no peeled cell and were judged as good. However, the primer layer of comparison example 1 in which neither of the CTA and the thermally cross-linkable curing agent was used, and the re-adhesive adhesion layer of comparison example 3 in which neither of the CTA and the thermally cross-linkable curing agent was used had 30 peeled cells and 23 peeled cells, respectively, and thus were judged as poor. In comparison examples 2 and 4 in which the CTA was used but the thermally cross-linkable curing agent was not used, the primer layer and the re-adhesive adhesion layer had a smaller number of peeled cells than those of comparison examples 1 and 3, but had 8 peeled cells and 12 peeled cells, respectively, and were judged as poor.

Therefore, the use of the CTA and the thermally cross-linkable curing agent in the primer layer and the re-adhesive adhesion layer may increase the adhesion of the primer layer and the re-adhesive adhesion layer. The above-described experiments for the primer layer and the re-adhesive adhesion layer were conducted separately, but, it is estimated from the results of the experiments that, if a double-sided tape is formed by forming the primer layer and the re-adhesive adhesion layer on the base layer, cohesion between the base layer and the primer layer and cohesion between the primer layer and the re-adhesive adhesion layer would be improved.

2. Manufacturing of Re-Adhesive Multi-Layered Double-Sided Tape

<Thickness Change Experiment>

As shown in following table 4, re-adhesive multi-layered double-sided tapes were manufactured by forming the primer layer of example 1 and the re-adhesive adhesion layer of example 3 on a PET film, and adhesion of the tape to paper was tested by changing thicknesses of the layers. The thickness of the base layer and the total thickness of the double-sided tape were fixed as 75 μm and 900 μm, respectively, and the thickness of the primer layer was changed and accordingly the thickness of the re-adhesive adhesion layer was relatively changed.

TABLE 4

| | | | | Ex- | | |
|---|---|---|---|---|---|---|
| | | | | am- | Exam- | Exam- |
| | Example 5 | Example 6 | Example 7 | ple 8 | ple 9 | ple 10 |
| Thickness | 75 | 75 | 75 | 75 | 75 | 75 |
| of base | | | | | | |
| layer (μm) | | | | | | |
| Thickness | 25 | 50 | 75 | 100 | 125 | 150 |
| of primer | | | | | | |
| layer (μm) | | | | | | |
| Thickness | 387.5 | 362.5 | 337.5 | 321.5 | 287.5 | 262.5 |
| of re- | | | | | | |
| adhesive | | | | | | |
| adhesion | | | | | | |
| layer(μm) | | | | | | |
| Thickness | 900 | 900 | 900 | 900 | 900 | 900 |
| of double- | | | | | | |
| sided tape | | | | | | |
| (μm) | | | | | | |
| Adhesion | Detached | Detached | Detached | Good | Good | Good |
| (Paper) | | | | | | |

It can be seen from table 4 that the resulting adhesion was good in examples 8, 9, and 10 in which the thickness of the primer layer was greater than that of the base layer. This was because that the primer layer and the re-adhesive adhesion layer were similar in view of their components, and, if the primer layer was thin, they would combine and react with each other, and the primer layer would not remain between the base layer and the re-adhesive adhesion layer.

<Thermal Cross-Linking Condition Change Experiment>

The re-adhesive multi-layered double-sided tape which was formed by forming the primer layer of example 1 and the re-adhesive adhesion layer of example 3 on the PET film was tested by changing a thermal curing temperature and a cross-linking time in the final thermal cross-linking and curing steps as shown in table 5 below, and the best thermal cross-linking and curing temperature and time were identified.

TABLE 5

| | Example | Example | Example | Example | Example | Example |
|---|---|---|---|---|---|---|
| | 11 | 12 | 13 | 14 | 15 | 16 |
| Thermal | 50 | 50 | 60 | 60 | 70 | 70 |
| curing | | | | | | |
| temperature | | | | | | |
| (° C.) | | | | | | |
| Thermal | 24 | 48 | 24 | 48 | 24 | 48 |
| curing time | | | | | | |
| (hour) | | | | | | |
| Maintainability | Fail | Fail | Maintained | Maintained | Maintained | Maintained |
| (60° C., 1 | | | | | | |
| hour) | | | | | | |
| State of | Good | Good | Good | Valley | Valley | Valley |
| primer | | | | generated | generated | generated |
| layer | | | | | | |

A re-adhesive multi-layered double-sided tape formed in examples 11 and 12 in which the thermal curing temperature was 50° C. was tested on whether adhesion was maintained at 60° C. for 1 hour. However, the adhesion was not maintained. On the other hand, in examples 13 to 16 in which the thermal curing temperature was higher than 60° C., adhesion was maintained. It was estimated that thermal crosslinking and curing were incompletely performed due to very low thermal curing temperature in examples 11 and 12.

Also, in examples in which the thermal curing temperature was 70° C. and example in which the thermal curing temperature was 60° C. and the thermal curing time was 48 hours, a valley was generated in the primer layer unlike in the state of the primer layer when coating was performed and thus there was a problem that the base layer and the re-adhesive adhesion layer were brought into contact with each other. This was because that, if the thermal curing temperature was very high, the re-adhesive adhesion layer melted into the primer layer and generated a valley. Therefore, the base layer formed under the primer layer was exposed and was brought into contact with the re-adhesive adhesion layer. Also, in example 14 in which the thermal curing was performed at 60° C. for 48 hours, it was estimated that the re-adhesive cohesion layer melted into the primer layer due to the long heating process. Also, if the thermal curing temperature was very high or thermal curing was performed for a long time, a degree of crosslinking increases and thus a tacking property may be reduced. Therefore, it may be preferable to perform thermal curing at 60° C. for 24 hours.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A re-adhesive multi-layered double-sided tape comprising:
a base layer;
primer layers which are formed on opposite surfaces of the base layer; and
re-adhesive adhesion layers which are formed on the primer layers.

2. The re-adhesive multi-layered double-sided tape as claimed in claim 1, wherein the base layer comprises polyethyleneterephthalate.

3. The re-adhesive multi-layered double-sided tape as claimed in claim 1, wherein the primer layer comprises a monomer, a first photo initiator, a second photo initiator, and a crosslinker.

4. The re-adhesive multi-layered double-sided tape as claimed in claim 1, wherein the re-adhesive adhesion layer comprises a monomer, a first photo initiator, a second photo initiator, and a crosslinker.

5. The re-adhesive multi-layered double-sided tape as claimed in claim 1, wherein at least one of the primer layer and the re-adhesive adhesion layer comprises a chain transfer agent (CTA).

6. The re-adhesive multi-layered double-sided tape as claimed in claim 5, wherein the CTA is a mercaptan-based CTA.

7. The re-adhesive multi-layered double-sided tape as claimed in claim 1, wherein at least one of the primer layer and the re-adhesive adhesion layer comprises a thermally cross-linkable curing agent.

8. The re-adhesive multi-layered double-sided tape as claimed in claim 7, wherein the thermally cross-linkable curing agent is an epoxy thermally cross-linkable curing agent.

9. The re-adhesive multi-layered double-sided tape as claimed in claim 1, wherein a thickness of the primer layer is thicker than that of the base layer and is thinner than that of the re-adhesive adhesion layer.

10. The re-adhesive multi-layered double-sided tape as claimed in claim 1, wherein a ratio of a thickness of the base layer and a thickness of the primer layer is more than 3:4.

11. A method for manufacturing a re-adhesive multi-layered double-sided tape, the method comprising:
forming primer layers by coating opposite surfaces of a base layer with primer layers and photo-curing the primer layers; and
forming an re-adhesive adhesion layer by coating the primer layer with a re-adhesive adhesion layer and photo-curing the re-adhesive adhesion layer.

12. The method as claimed in claim 11, wherein the forming the primer layers comprises:
photo-curing a first primer mixture in which a primer monomer and a first primer layer photo initiator are mixed; and
coating the opposite surfaces of the base layer with a second primer mixture in which a second primer layer photo initiator and a primer layer crosslinker are added to the first primer mixture, and photo-curing the second primer mixture.

13. The method as claimed in claim 11, wherein the forming the re-adhesive adhesion layer comprises:
photo-curing a first adhesion layer mixture in which an adhesion layer monomer and a first adhesion layer photo initiator are mixed; and
coating the primer layer with a second adhesion layer mixture in which a second adhesion layer photo initiator and an adhesion layer crosslinker are added to the first adhesion layer mixture, and photo-curing the second adhesion layer mixture.

14. The method as claimed in claim 11, wherein at least one of the primer layer and the re-adhesive adhesion layer comprises a thermally cross-linkable curing agent,
wherein the method further comprises, after photo-curing, thermally crosslinking and curing the primer layer and the re-adhesive adhesion layer.

15. The method as claimed in claim 14, wherein the thermally crosslinking and curing are performed at a temperature of 60° C. within 24 hours.
